(19) United States
(12) Patent Application Publication
(10) Pub. No.: US 2025/0132369 A1
(43) Pub. Date: Apr. 24, 2025

(54) MAGAZINE WITH DIRECTION INDICATOR AND SECONDARY BATTERY MANUFACTURING APPARATUS INCLUDING THE SAME

(71) Applicant: SK On Co., Ltd., Seoul (KR)

(72) Inventors: Dong Hee JEONG, Daejeon (KR); Jae Young JUNG, Daejeon (KR)

(21) Appl. No.: 18/810,541

(22) Filed: Aug. 21, 2024

(30) Foreign Application Priority Data
Oct. 19, 2023 (KR) 10-2023-0140311

(51) Int. Cl. H01M 10/04

(52) U.S. Cl. CPC H01M 10/0404

(57) ABSTRACT

A secondary battery manufacturing apparatus includes a seating table, a magazine seated on the seating table and in which at least one electrode plate is loaded in a first direction, a direction indicator provided with the magazine and indicating a relative direction of the magazine with respect to the seating table, and a direction recognition unit sensing the direction indicator and deriving a direction in which the magazine has been seated on the seating table, thereby preventing the magazine from being seated on a seating table in a reverse direction rather than a preset forward direction.

### CROSS-REFERENCE TO RELATED APPLICATIONS

This patent document claims the priority and benefits of Korean Patent Application No. 10-2023-0140311 filed on Oct. 19, 2023, the disclosure of which is incorporated herein by reference in its entirety.

### TECHNICAL FIELD

The disclosure and implementations disclosed in this patent document generally relate to a magazine and a secondary battery manufacturing apparatus including the same.

### BACKGROUND

Recently, as the technological development of, and demand for, devices such as mobile devices and electric vehicles have increased, demand for secondary batteries as an energy source is rapidly increasing. A secondary battery is a battery that may be repeatedly charged and discharged through reversible energy conversion between chemical energy and electrical energy.

Such secondary batteries include an electrode assembly containing a positive electrode, a negative electrode, and a separator disposed therebetween. Electrodes such as a positive electrode and a negative electrode may be separately loaded into a magazine and then input into the secondary battery manufacturing apparatus. The secondary battery manufacturing apparatus may manufacture a secondary battery including an electrode assembly by alternately stacking positive and negative electrodes loaded in a magazine.

On the other hand, it is important in terms of safety to ensure that the magazine containing the electrodes is inserted into the secondary battery manufacturing apparatus in a preset forward direction.

This is because if the magazine is inserted into the secondary battery manufacturing apparatus in the reverse direction, the electrodes loaded in the magazine may also be provided to the secondary battery manufacturing apparatus in the reverse direction. In this case, safety problems may arise as electrodes with different electrical polarities come into contact.

For example, in the case in which a positive magazine loaded with positive electrodes is introduced in the forward direction and a magazine loaded with negative electrodes is introduced in the reverse direction, the positive electrodes may be stacked in the forward direction and the negative electrodes may be stacked in the reverse direction. At this time, a fire or explosion may occur when the positive electrodes stacked in the forward direction and the negative electrodes stacked in the reverse direction contact each other.

In detail, inserting the magazine in the correctly designed forward direction may be important not only in the secondary battery manufacturing process, but also in terms of the safety of the manufactured secondary battery.

Accordingly, there is a need for a structure that may effectively prevent the magazine from being inserted in the reverse direction.

### SUMMARY

The present disclosure may be implemented in some embodiments to improve safety in a secondary battery manufacturing process by preventing a magazine in which electrodes are loaded from being inserted in a reverse direction.

The present disclosure may be implemented in some embodiments to provide the size of a magazine to be variable according to the size of a loaded electrode, such that the electrode may be stably supported.

In some embodiments of the present disclosure, a secondary battery manufacturing apparatus includes a seating table; a magazine seated on the seating table and in which one or more electrode plates are loaded in a first direction; a direction indicator provided in the magazine and indicating a relative direction of the magazine with respect to the seating table; and a direction recognition unit sensing the direction indicator and deriving a direction in which the magazine has been seated on the seating table, thereby preventing the magazine from being seated on a seating table in a reverse direction rather than a preset forward direction.

The magazine may enter and may be seated on the seating table in a second direction, perpendicular to the first direction.

The direction indicator may be disposed on a surface of the magazine, facing a direction perpendicular to the second direction.

The direction indicator may include a notch portion provided to face the seating table on the surface on which the magazine is seated on the seating table, and the direction recognition unit may include a notch sensor disposed to face the magazine on the seating table and sensing the notch portion.

The notch sensor may sense the notch portion overlapping in the first direction.

The magazine may be seated on the seating table in a plurality of seating directions, and the notch portion may be disposed to overlap the notch sensor in the first direction when the magazine is seated on the seating table in the first seating direction.

The notch portion may not overlap the notch sensor in the first direction when the magazine is seated on the seating table in a second seating direction rather than the first seating direction.

The notch portion may be disposed to be deflected in a predetermined direction in the magazine, based on a direction perpendicular to the first direction.

The direction indicator may include a mark portion disposed in a direction perpendicular to the first direction and exposed externally, and the direction recognition unit may include a mark sensor disposed to face the seating table in a direction, perpendicular to the first direction, and sensing the mark portion.

The mark sensor may sense the mark portion disposed on a facing first surface among surfaces of the magazine seated on the seating table.

The magazine may be seated on the seating table in a plurality of seating directions, and the mark portion may be disposed on the first surface of the magazine when the magazine is seated on the seating table in a first seating direction.

The mark portion may be disposed so as not to face the mark sensor when the magazine is seated on the seating table in a second seating direction rather than the first seating direction of the magazine.

The mark sensor may be provided as a plurality of mark sensors, and the plurality of mark sensors may be disposed not to face each other in a predetermined direction.

In some embodiments of the present disclosure, a magazine includes a loading space in which an electrode plate with an uncoated portion protruding in a predetermined direction is loaded in a first direction; a loading guide having the loading space; and a direction indicator indicating a protruding direction of the uncoated portion of the electrode plate. The direction indicator includes at least one of a notch portion disposed below the loading space in the first direction, or a mark portion provided to be exposed externally on a surface perpendicular to the first direction.

The magazine may further include a base plate supporting a lower portion of the loading guide, and the notch portion may be disposed so as not to overlap the loading space in the first direction in the base plate.

The loading guide may be provided to be movable in a direction, perpendicular to the first direction, and to change a size of the loading space.

The magazine may further include a moving frame supporting an end of the loading guide in the first direction and having a moving guide hole provided in a second direction, perpendicular to the first direction, and the loading guide may be movable in the second direction along the moving guide hole of the moving frame.

The magazine may further include a side frame supporting a side portion of the loading guide and having a side guide hole extending in the second direction, and the loading guide may move in the second direction along the moving guide hole and the side guide hole.

The magazine may further include a base plate supporting the moving frame and having a base guide hole extending in a third direction, perpendicular to the first and second directions, and the moving frame may be provided to be movable in the third direction along the base guide hole together with the loading guide.

The magazine may further include a support plate disposed in the second direction of the loading guide, supporting the side frame and having a support guide hole extending in the third direction, and the side frame may move in the third direction along the support guide hole together with the loading guide.

### BRIEF DESCRIPTION OF DRAWINGS

Certain aspects, features, and advantages of the present disclosure are illustrated by the following detailed description with reference to the accompanying drawings.

FIG. 1 is a perspective view of a magazine according to some embodiments.

FIG. 2 is an exploded perspective view of a magazine according to some embodiments.

FIG. 3 is a diagram illustrating a magazine being changed in a predetermined direction according to some embodiments.

FIG. 4 is a diagram illustrating a magazine being changed in different directions according to some embodiments.

FIG. 5 is a diagram illustrating a magazine entering a seating table.

FIG. 6 is a diagram illustrating a state in which the magazine is seated on the seating table.

FIG. 7 is a schematic diagram of determining a seating direction through a notch portion and a notch sensor.

FIG. 8 is a schematic diagram of determining a seating direction through a mark portion and a mark sensor.

FIG. 9 is a schematic diagram of determining a seating direction using both a notch sensor and a mark sensor.

FIG. 10 is a flowchart of a method of determining a seating direction of a magazine according to some embodiments.

### DETAILED DESCRIPTION

Features of the present disclosure disclosed in this patent document are described by example embodiments with reference to the accompanying drawings.

Prior to the detailed description of example embodiments, terms or words used in the descriptions below and claims should not be construed as being limited to their usual or dictionary meanings, and should be interpreted with meaning and concept consistent with the technical idea of the present disclosure, based on the principle that the inventor may appropriately define the concept of terms to explain his or her invention in the best way.

The same reference numbers or symbols in respective drawings indicate parts or components that perform substantially the same function.

In the following description, singular expressions include plural expressions unless the context clearly dictates otherwise. Terms such as “include,” “configure” and the like are intended to designate the presence of features, numbers, steps, operations, components, parts, or combinations thereof described in the specification, and should be understood as not precluding the presence or addition of one or more other features, numbers, steps, operations, components, parts, or combinations thereof.

In addition, in the following description, expressions such as upper side, upper portion, lower, bottom, side, front, rear, and the like are expressed based on the direction illustrated in the drawing, and it should be noted in advance that if the direction of the object is changed, it may be expressed differently.

Additionally, in the descriptions below and claims, terms including ordinal numbers such as “first,” “second,” and the like may be used to distinguish between components. These ordinal numbers are used to distinguish identical or similar components from each other, and the meaning of the term should not be interpreted limitedly due to the use of these ordinal numbers. For example, components combined with these ordinal numbers should not be interpreted as having a limited order of use or arrangement based on the number. If necessary, respective ordinal numbers may be used interchangeably.

Before describing the present disclosure, a magazine used in a secondary battery manufacturing apparatus will be described.

The magazine may be input into the secondary battery manufacturing apparatus with a plurality of electrode plates loaded in the loading space. Afterwards, the secondary battery manufacturing apparatus may withdraw the electrode plate from the inserted magazine and perform subsequent manufacturing operations such as a stacking process.

At this time, if the magazine is inserted into the secondary battery manufacturing apparatus in a direction (hereinafter referred to as reverse direction) other than the preset direction (hereinafter referred to as forward direction), the electrode plate loaded in the magazine is also supplied to the secondary battery manufacturing apparatus in the reverse direction.

If the electrode plate is supplied in the reverse direction, a fire or explosion may occur due to contact between an electrode plate loaded in the forward direction and an electrode plate with a different electrode loaded in the reverse direction during the secondary battery manufacturing process. Accordingly, the direction of the magazine loading the electrode plates therein may be an important factor in the secondary battery manufacturing process.

Additionally, electrode plates of various sizes may be required depending on the device used for the secondary battery, and the magazine may provide electrode plates of various sizes to the secondary battery manufacturing apparatus.

At this time, if the loading space of the magazine is too large than the size of the electrode plates, the alignment between the plurality of electrode plates loaded in the magazine may be disturbed, resulting in defects. On the other hand, if the loading space of the magazine is smaller than the size of the electrode plate, the electrode plate may be bent or broken when loaded into the magazine.

As a result, it may be important to adjust the size of the magazine's loading space to accommodate the various sizes of electrode plates.

In a magazine 100 according to some embodiments of the present disclosure, the size of the loading space is variable to correspond to the size of the electrode plate, thereby increasing manufacturing efficiency. Additionally, the magazine 100 according to some embodiments may be prevented from being inserted into the secondary battery manufacturing apparatus in the reverse direction, thereby increasing safety.

Hereinafter, the present disclosure will be described with reference to the drawings.

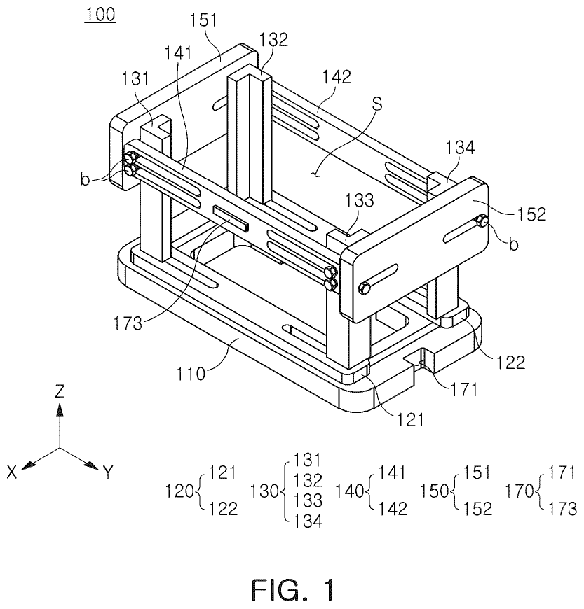

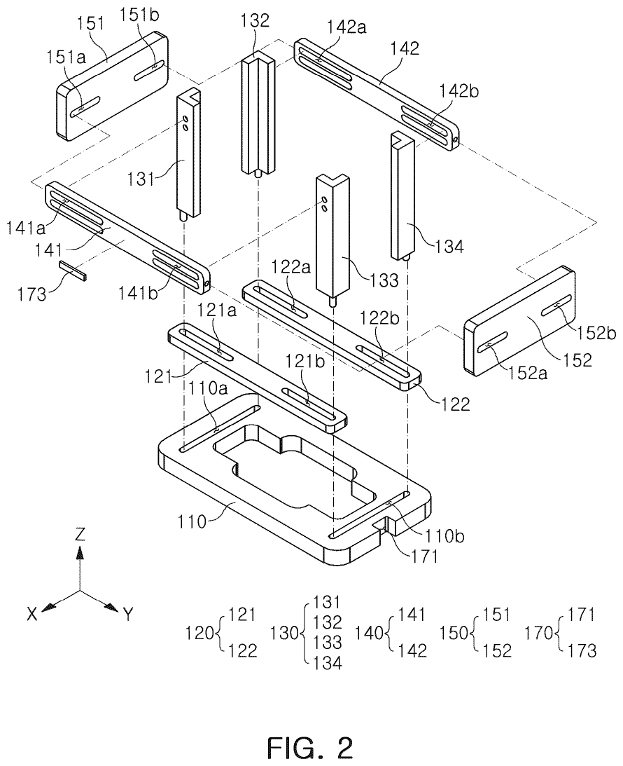

FIG. 1 is a perspective view of a magazine according to some embodiments, and FIG. 2 is an exploded perspective view of a magazine according to an embodiment.

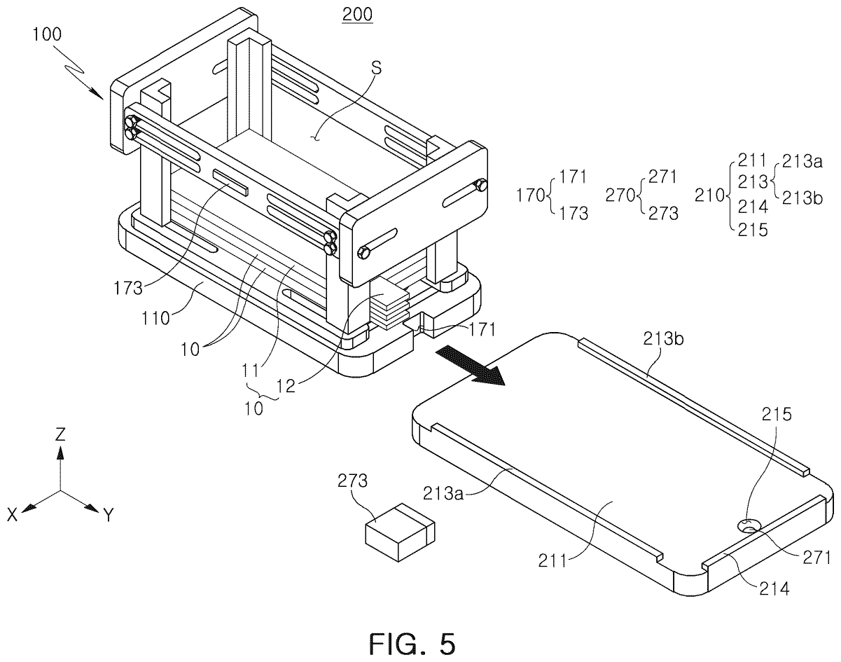

Referring to FIGS. 1 and 2, the magazine 100 according to an embodiment may include a loading guide 130 that supports the corners of the electrode plate 10 (see FIG. 5) to form a loading space S, a moving frame 120 supporting the lower portion of the loading guide 130, and a base plate 110 that supports the moving frame 120 and may be mounted on a seating table 210 of the secondary battery manufacturing apparatus to be described later.

A plurality of loading guides 130 may be provided to form a loading space S in which the electrode plate 10 (see FIG. 5) is loaded. The plurality of loading guides 130 may support respective corners of the electrodes.

As an example, the loading guide 130 includes a first loading guide 131, a second loading guide 132, a third loading guide 133, and a fourth loading guide 134, and may support four respective corners of the electrode plate (10, see FIG. 5).

In addition, the loading guide 130 may be provided so that the size thereof may be changed in one direction (for example, the Y-axis direction in the drawing) and another direction (for example, the X-axis direction in the drawing) perpendicular thereto. Therefore, the size of the loading space S of the magazine 100 may be varied.

The loading guide 130 may move in one direction (for example, the Y-axis direction in the drawing) along the moving frame 120 and the side frame 140, which will be described later. Additionally, the loading guide 130 may move in another direction (for example, the X-axis direction in the drawing). Therefore, the magazine 100 according to an embodiment may vary the size of the loading space S.

The structure in which the loading space S of the magazine 100 is varied by movement of the loading guide 130 will be described later.

The moving frame 120 may support the lower portion of the loading guide 130. The moving frame 120 may support one side and the other side of the loading guide e 130, respectively.

As an example, the moving frame 120 may include a first moving frame 121 supporting the lower portions of the first loading guide 131 and the third loading guide 133 disposed on one side of the loading guide 130, and a second moving frame 122 supporting the lower portions of the second loading guide 132 and the fourth loading guide 134 disposed on the other side.

The first moving frame and the second moving frame 121 and 122 may include first moving guide holes 121a and 122a disposed on one side and second moving guide holes 121b and 122b disposed on the other side, respectively. The loading guide 130 may move in the longitudinal direction (for example, the Y-axis direction in the drawing) of the moving frame 120 along the first moving guide holes 121a and 122a and the second moving guide holes 121b and 122b.

The base plate 110 may be disposed below the moving frame 120 to support the moving frame 120. When the base plate 110 is input into the secondary battery manufacturing apparatus, the base plate 110 may be seated on the seating table 210 (see FIG. 5), which will be described later.

Additionally, the base plate 110 may guide the moving frame 120 to move in the width direction (for example, the X-axis direction in the drawing). When the moving frame 120 moves in the width direction, the loading guide 130 moves along with the moving frame 120 in the width direction, and the width thereof in the width direction may change.

As an example, the base plate 110 may include a first base guide hole 110a provided on one side and a second base guide hole 110b provided on the other side. The first base guide hole 110a may movably support one sides of the first moving frame 121 and the second moving frame 122. The second base guide hole 110b may movably support the other sides of the first moving frame 121 and the second moving frame 122.

According to some embodiments, a fixing member b coupling respective components may be further included. FIG. 2 is illustrated with the fixing member b omitted for convenience of understanding. The fixing member b may couple the base plate 110 and the moving frame 120 to each other while penetrating the base guide holes 110a and 110b and the moving guide holes 121a, 121b, 122a and 122b.

In addition, the fixing member b may couple the moving frame 120 and the lower portion of the loading guide 130 to each other, while penetrating the moving guide holes 121a, 121b, 122a, and 122b.

For example, the moving frame 120 may be coupled to the base plate 110 to be movable in the width direction, and the loading guide 130 may be respectively coupled to the moving frame 120 to be movable in the longitudinal direction.

Additionally, the magazine 100 according to some embodiments may include a side frame 140 supporting the side of the loading guide 130 and a support plate 150 supporting the side of the side frame 140.

The side frame 140 may support the side of the loading guide 130. In this case, the side may mean, for example, a side in a direction perpendicular to the entry direction (Y-axis direction, see FIG. 5), which will be described later.

The side frame 140 is disposed above the moving frame 120 and may be coupled to the side of the loading guide 130 through the fixing member b.

Additionally, the side frame 140 may include a first side frame 141 supporting one side of the loading guide 130 and a second side frame 142 supporting the other side. The first side frame 141 and the second side frame 142 may include first side guide holes 141a and 142a provided on one side in the longitudinal direction and second side guide holes 141b and 142b provided on the other side, respectively.

Therefore, the loading guide 130 may be moved in the longitudinal direction of the side frame.

The support plate 150 may be disposed in a direction adjacent to the side frame 140 with respect to the loading guide 130. For example, the side frame 140 may be disposed perpendicular to the entering direction of the magazine 100, and the support plate 150 may be disposed parallel to the entering direction of the magazine 100.

The support plate 150 may include a first support plate 151 movably supporting one side of the side frame 140 and a second support plate 152 movably supporting the other side.

The first and second support plates 151 and 152 may include first support guide holes 151a and 152a that guide the movement of the first side frame 141 and second support guide holes 151b and 152b that guide the movement of the second side frame 142, respectively.

The side frame 140 may move in the width direction along the support plate 150, and therefore, the size of the loading guide 130 in the width direction may also be changed.

The fixing member b passes through the support guide holes 151a, 151b, 152a and 152b and is coupled to the first and second side frames 141 and 142, thereby fixing the support plate 150 and the side frame 140.

On the other hand, the magazine 100 according to some embodiments may further include a direction indicator 170 recognized by a direction recognition unit 270 of the secondary battery manufacturing apparatus, which will be described later.

The direction indicator 170 is provided with the magazine 100 and may indicate the relative direction of the magazine 100 with respect to the seating table 210, which will be described later. For example, whether the magazine 100 is disposed on the seating table 210 in the forward or reverse direction may be determined through the direction indicator 170.

The direction indicator 170 may include at least one of a notch portion 171 provided on a lower portion of the magazine 100, in detail, on the base plate 110, or a mark portion 173 provided on a side portion of the magazine 100, in detail, on the side frame 140. For example, as illustrated in FIGS. 1 to 4, the direction indicator 170 may include both the notch portion 171 and the mark portion 173. Alternatively, the direction indicator 170 may include only one of the notch portion 171 and the mark portion 173.

The structure of determining the seating direction of the magazine 100 through the direction indicator 170 and the direction recognition unit 270 recognizing the direction indicator will be described later with reference to FIGS. 5 to 9.

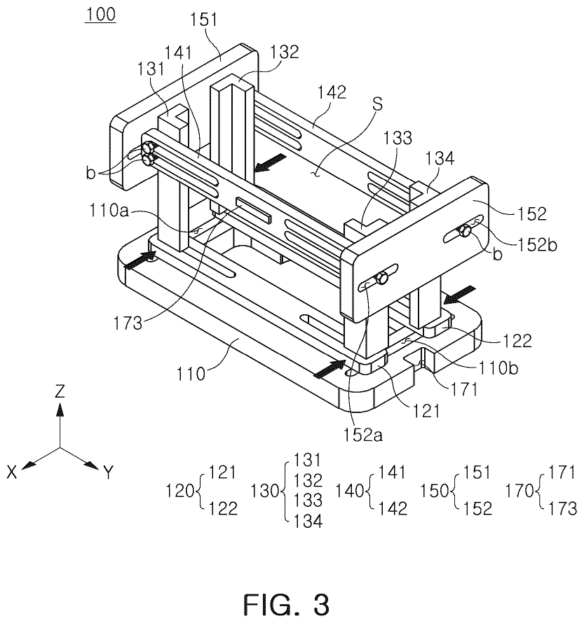

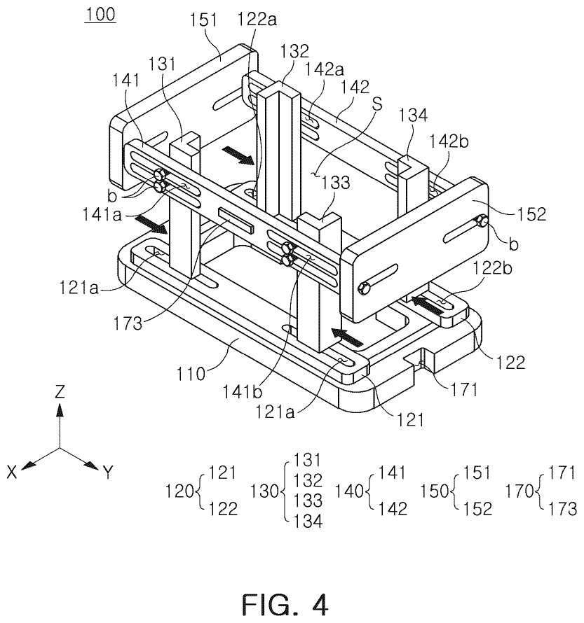

Hereinafter, with reference to FIGS. 3 and 4, a structure in which the loading space S is variable will be described.

FIG. 3 is a view illustrating that the accommodating space of the magazine changes in the width direction according to some embodiments, and FIG. 4 is a view illustrating the accommodating space of the magazine changing in the longitudinal direction according to some embodiments.

In this case, as described above, the ‘width direction’ may be the X-axis in the drawing, and the ‘longitudinal direction’ may be the Y-axis in the drawing.

Referring to FIG. 3, according to some embodiments, the width of the loading space S may be varied in the width direction of the loading guide 130 so that the width of the loading space S may be changed. In the drawing, the width of the loading space S is illustrated to be reduced, but the embodiment is not limited thereto, and of course, unlike the drawing, the loading space may be changed to increase the width in the width direction.

The lower portion of the loading guide 130 may be coupled to the moving frame 120 and the base plate 110 through the fixing member b, and the side portion thereof may be coupled to the side frame 140 through the fixing member b.

In this case, the first moving frame 121 and the second moving frame 122 may respectively move toward or away from each other in the width direction along the first base guide hole 110a and the second base guide hole 110b.

In addition, the first side frame 141 and the second side frame 142 may respectively move toward or away from each other in the width direction along the first support guide holes 151a and 152a and the second support guide holes 151b and 152b.

In detail, the lower portion of the loading guide 130 may move in the width direction of the base plate 110 through the moving frame 120, and the side portion of the loading guide 130 may move in the width direction of the support plate 150 through the side frame 140.

Therefore, the first loading guide 131 and the second loading guide 132, and the third loading guide 133 and the fourth loading guide 134, facing each other in the width direction, may have widths to be changed to be closer to or farther away from each other.

When the width of the loading guide 130 is changed, the width of the loading space S may also be changed.

Referring to FIG. 4, according to some embodiments, the width of the loading guide 130 in the width direction may be varied so that the width of the loading space S in the longitudinal direction decreases. In the drawing, the longitudinal width of the loading space S is illustrated to be reduced, but the embodiment is not limited thereto, and of course, unlike the drawing, the longitudinal width of the loading space S may be changed to increase.

As described above, the lower portion of the loading guide 130 may be coupled to the moving frame 120 to be movable in the longitudinal direction. Additionally, the side portion of the loading guide 130 may be coupled to the side frame 140 to be movable in the longitudinal direction.

In detail, the lower portion of the loading guide 130 may move in the longitudinal direction along the first moving guide holes 121a and 122a and the second moving guide holes 121b and 122b that extend long in the longitudinal direction.

In addition, the side portion of the loading guide 130 may move in the longitudinal direction along the first side guide holes 141a and 142a and the second side guide holes 141b and 142b that extend long in the longitudinal direction.

Therefore, widths of the first loading guide 131 and the third loading guide 133, and the second loading guide 132 and the fourth loading guide 134, facing each other in the longitudinal direction, may be changed to get closer or further away from each other in the longitudinal direction (the direction of extension of the guide hole described above).

For example, when the width of the loading guide 130 changes as it moves in the longitudinal direction, the longitudinal size of the loading space S may also change.

In this manner, the loading space S of the magazine 100 according to some embodiments may be variable in the width direction (for example, the X-axis direction in the drawing) and/or the longitudinal direction (for example, the Y-axis direction in the drawing).

Hereinafter, before describing a structure in which the direction of the magazine 100 may be sensed through the magazine 100 equipped with the direction indicator 170 according to some embodiments, the configuration of a secondary battery manufacturing apparatus 200 related to the magazine 100 equipped with the direction indicator 170 according to an embodiment will first be described.

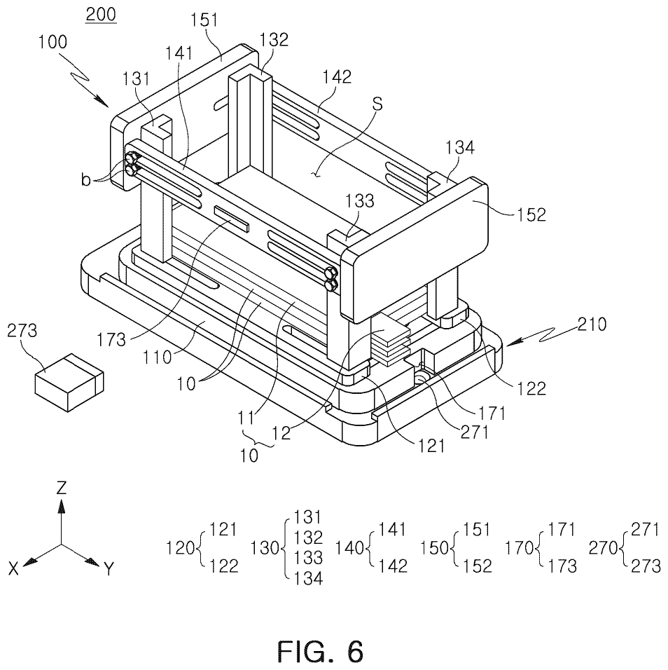

FIG. 5 is a diagram illustrating a magazine entering a seating table according to some embodiments, and FIG. 6 is a diagram illustrating a state in which a magazine is seated on a seating table according to an embodiment. The description will be omitted to the extent that it overlaps with the content described above in FIGS. 1 to 4.

Referring to FIGS. 5 and 6, the secondary battery manufacturing apparatus according to some embodiments may include a magazine 100 and a seating table 210 on which the magazine 100 is mounted.

The seating table 210 may provide a space where the magazine 100 may be seated. The secondary battery manufacturing apparatus 200 may perform a secondary battery manufacturing process by pulling out the electrode plate 10 loaded on the magazine 100 mounted on the seating table 210.

On the other hand, the electrode plate 10 is part of a secondary battery produced as a result of the secondary battery manufacturing apparatus, and may include a positive electrode plate coated with a positive electrode active material and a negative electrode plate coated with a negative electrode active material.

The electrode plate 10 may include a body portion 11 to which the active material is applied, and an uncoated portion 12 that protrudes to one side of the body portion 11 and to which the active material is not applied.

As described above, if the magazine 100 is inserted into the secondary battery manufacturing apparatus 200 in the reverse direction, the protruding direction of the uncoated portion 12 is also disposed in the reverse direction, and thus, during the subsequent manufacturing process, a fire may occur due to contact with an uncoated portion of an electrode plate having a different electrical polarity.

The seating table 210 may include a seating portion 211 on which the base plate 110 of the magazine 100 may be seated, and a seating guide 213 that guides the magazine 100 to be seated on the seating table 210.

The seating portion 211 provides a space where the base plate 110 of the magazine 100 may be seated. The seating portion 211 may be provided with a notch sensor 271 that senses the notch portion 171, which will be described later.

As an example, the seating table 210 is provided with a sensor hole 215 in a position parallel to the notch portion 171 and the height direction (Z-axis direction in the drawing) in a state in which the magazine 100 is seated on the seating portion, and a notch sensor 271 may be accommodated in the sensor hole 215.

Therefore, the notch sensor 271 may not protrude from the seating portion 211, external noise may be reduced, and the notch portion 171 may be recognized more accurately.

On the other hand, the meaning of ‘seat’ explained in this disclosure does not mean the process of placing the magazine 100 on the seating table 210, but is a state in which the entry of the magazine 100 is completed, and may mean a state in which the magazine 100 is completely disposed on the seating table 210 and does not enter further so that the direction recognition unit 270 to be described later may recognize the direction indicator 170 provided in the magazine 100.

As an example, the seated state may mean a state in which the magazine 100 is supported by the seating guide 213 and a seating stopper 214.

On the other hand, FIGS. 5 and 6 illustrate that the magazine 100 enters the seating table 210 in the +Y axis direction and is seated on the seating table 210, but the entry direction of the magazine 100 in the present disclosure is not particularly limited. For example, the magazine 100 may be seated on the seating table 210 while entering the seating table 210 from above downwards (entering in the Z-axis direction).

The seating guide 213 may guide the magazine 100 to be seated on the seating table 210. The seating guide 213 may include a first seating guide 213a disposed in a direction perpendicular to the entry direction of the magazine 100 and guiding one side of the magazine 100, and a second seating guide 213b that guides the other side of the magazine 100.

The seating guide 213 may be provided to protrude from both ends of the seating portion 211 in the width direction to guide the base plate 110 and to support both sides of the base plate 110 in the width direction.

For example, the separation distance between the first seating guide 213a and the second seating guide 213b may correspond to the width of the base plate 110 in the width direction.

Therefore, the magazine 100 may enter the seating table 210 while both sides of the base plate 110 are guided by the seating guide 213.

The seating table 210 may further include a seating stopper 214 that blocks the entry surface of the magazine 100. In this case, the entry surface may be a surface facing the seating table 210 based on the traveling direction of the magazine 100. In the drawing, the entry surface may refer to at least one of one side of the base plate 110 or the second support plate 152.

Through the seating guide 213 and the seating stopper 214, the magazine 100 may be disposed and seated on the seating table 210 so that the direction indicator 170 may be recognized by the direction recognition unit 270.

In addition, according to some embodiments, a direction recognition unit 270 capable of recognizing the direction indicator 170 of the magazine 100 and identifying the direction of the magazine 100 seated on the seating table 210 may be further included.

As an example, a secondary battery manufacturing apparatus in the present disclosure may determine whether the magazine 100 is seated on the seating table 210 in the forward or reverse direction through the degree to which the direction recognition unit 270 recognizes the direction indicator 170.

On the other hand, in the present disclosure, the direction recognition unit 270 may not only recognize the direction indicator 170 that indicates the direction, but also determine whether the magazine 100 is seated in the forward direction based on the result of recognizing the direction indicator 170. In detail, the direction recognition unit 270 not only recognizes the direction indicator 170 but may also derive the seating direction of the magazine 100.

In addition, in the present disclosure, the function of the direction recognition unit 270 is described as ‘recognize,’ but this is only an example and may mean both detection or sensing. In detail, if the direction recognition unit 270 may derive the seating direction of the magazine 100 through the presence of the direction indicator 170, the function of the direction recognition unit 270 is not particularly limited.

On the other hand, before describing the direction indicator 170 that indicates the seating direction of the magazine 100 and the direction recognition unit 270 that recognizes the same, the concepts of forward and reverse directions described in this disclosure will be explained.

In the present disclosure, the forward direction and the preset direction may be used in a relative sense. In detail, ‘forward direction’ may mean any one of the predetermined seating directions of the magazine 100. ‘Reverse direction’ is determined relatively in relation to the forward direction, and the reverse direction may mean any seating direction other than the forward direction. For example, among several cases related to the seating direction of the magazine 100, any one case may be set to the forward direction.

For example, in the present disclosure, the forward direction may refer to a direction in which the electrode plate 10 accommodated in the magazine 100 is disposed in the correct pre-designed direction, and the reverse direction may refer to any direction other than the forward direction.

In addition, the determination of whether the magazine 100 is seated on the seating table 210 in the forward or reverse direction is not only determined by the relationship between the magazine itself and the seating table, but may also be defined as a relative concept including the placement direction of the electrodes accommodated in the magazine 100.

For example, the forward direction may be preset to be a direction in which the direction in which the uncoated portion 12 of the electrode plate 10 protrudes and the entry direction of the magazine are the same as each other, as illustrated in FIG. 5. In this case, the reverse direction may refer to the direction in which the magazine 100 is seated such that the uncoated portion 12 of the electrode plate 10 loaded in the magazine 100 protrudes in a direction that is not the same as the entry direction of the magazine 100 (for example, the opposite direction). However, this is only an example, and the forward direction of the magazine may be set by the user regardless of the magazine insertion direction.

Additionally, the seating direction of the magazine 100 may be set in advance through the direction recognition unit 270, which will be described later. In detail, the direction recognition unit 270, which will be described later, may relatively determine whether the magazine 100 is disposed in any one preset direction.

As an example, the state in which the direction recognition unit 270 recognizes the direction indicator 170 may be preset to the forward direction, and in this case, the state in which the direction recognition unit 270 does not recognize the direction indicator 170 may be referred to as reverse direction. In detail, a state in which the sensor of the direction recognition unit 270 (for example, a notch sensor 271 or/and a mark sensor 273, which will be described later) senses the direction indicator 170, for example, a state in which the sensor is ON, may refer to a state in which the direction recognition unit 270 has recognized the direction indicator 170. In this case, the direction recognition unit 270 may generate a forward input signal.

On the other hand, this is only an example, and it goes without saying that the state in which the sensor of the direction recognition unit 270 is turned off may be modified to recognize the direction indicator 170 and to generate a forward input signal.

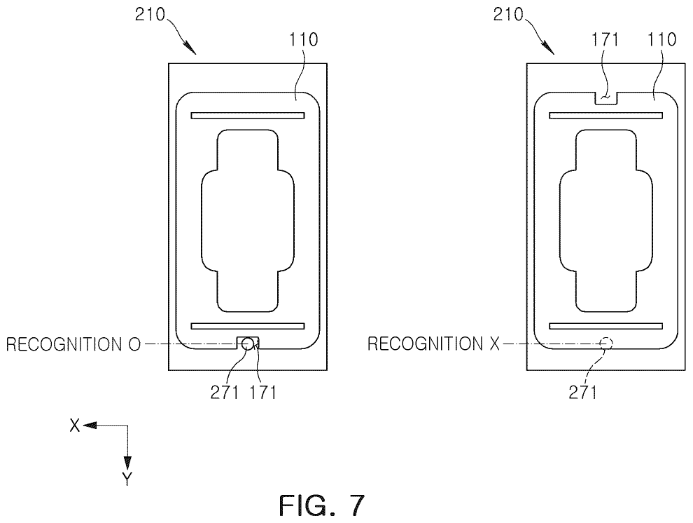

In detail, any structure that may determine the seating direction of the magazine 100 through recognition of the direction indicator 170 may belong to the present disclosure, which will be described later with reference to FIGS. 7 to 9.

In this manner, in some embodiments of the present disclosure, reverse insertion of the magazine 100 may be prevented more quickly and accurately by presetting the seating direction of the magazine 100 through the relationship with the direction recognition unit 270 described above.

In this case, the direction recognition unit 270 itself may not determine whether the magazine 100 is in the forward direction.

In detail, through whether the real-time recognition result of the direction recognition unit 270 matches the concept of the preset forward direction (recognition result of the direction recognition unit 270 that is preset as a forward direction), it may be determined whether the magazine 100 is in the forward direction (see FIGS. 7 to 9).

Hereinafter, with reference to the drawings, a magazine 100 having a direction indicator 170 and a secondary battery manufacturing apparatus 200 capable of recognizing the direction of the magazine 100 through a direction recognition unit 270 are described.

The magazine 100 according to some embodiments may include a direction indicator 170 that indicates the direction. The direction indicator 170 may indicate the direction of the electrode plate 10 accommodated in the loading space S or the direction in which the magazine 100 is seated on the seating table 210.

The direction indicator 170 is disposed in a specific direction of the magazine 100 and may indicate the relative direction of the magazine 100 with respect to the seating table 210 when the magazine 100 is seated. The direction recognition unit 270, which will be described later, recognizes the relative direction of the direction indicator 170 and may thereby derive the seating direction of the magazine 100.

As an example, the direction indicator 170 disposed on a specific surface of the magazine 100 may be disposed at different positions on the seating table 210 (see FIGS. 7 to 9) depending on the seating direction of the magazine 100 when the magazine 100 is seated on the seating table 210. At this time, the predetermined position of the direction indicator 170 with respect to the magazine 100 and the seating table 210 may be defined as the forward direction. As a result, the direction recognition unit 270 may determine the forward direction through whether the direction indicator 170 is disposed at the predetermined position among the plurality of seating directions of the magazine 100.

For example, the direction indicator 170 indicates the relative direction of the magazine 100 with respect to the seating table 210, thereby deriving the seating direction of the magazine 100.

On the other hand, the direction indicator 170 may indicate the protrusion direction of the uncoated portion 12 (see FIG. 5) provided in the electrode plate 10 (see FIG. 5) accommodated in the magazine 100 regardless of the secondary battery manufacturing apparatus 200. In this case, it may be determined whether the electrode plate 10 is received in the magazine 100 in the forward direction through the relative relationship between the direction indicator 170 and the uncoated portion 12.

For example, if the forward direction is defined as the case in which the direction indicator 170 is provided parallel to the protruding direction of the uncoated portion 12, the case in which the uncoated portion 12 is not disposed parallel to the direction indicator 170 may be determined to be in the reverse direction.

Therefore, the user may easily determine whether the uncoated portion 12 is loaded in the magazine 100 in the forward direction by only looking at the direction indicator 170.

In detail, the direction indicator 170 may indicate the seating direction of the magazine 100 with respect to the seating table 210 when the magazine 100 is seated on the seating table 210. In addition, the direction indicator 170 may indicate the loading direction of the electrode plate 10 accommodated in the magazine 100, for example, the protrusion direction of the uncoated portion 12.

Additionally, the direction indicator 170 may be provided to be exposed to the outside of the magazine 100 and may be provided in a structure that may be recognized by the direction recognition unit 270.

As an example, the direction indicator 170 may be provided on the outer surface of the magazine so that it may be recognized from the outside. The secondary battery manufacturing apparatus 200 recognizes or does not recognize the direction indicator 170 provided in the magazine 100 through the direction recognition unit 270, and thus, it may be determined whether the magazine 100 is seated on the seating table 210 in the forward or reverse direction.

The direction indicator 170 may include at least one of a notch portion 171 disposed to face the seating portion 211 or a mark portion 173 disposed in a direction perpendicular to the loading direction (first direction, Z-axis direction in the drawing) of the electrode plate 10 loaded in the magazine 100.

The notch portion 171 may be provided at a portion where the magazine 100 is seated on the seating table 210, for example, the base plate 110. The notch portion 171 may be provided in a shape that penetrates the base plate 110 in the first direction (Z-axis direction in the drawing). In an example, the notch portion 171 may be located at the exact center of one side of the base plate 110, but alternatively, may be located adjacent to an edge of the one side. Additionally, the notch portion 171 may have a shape recessed from one side of the base plate 110, but alternatively, may have a hole shape that completely penetrates the base plate 110. In this case, the direction recognition unit 270 may be formed in a position corresponding to the notch portion 171.

The notch portion 171 may be recognized by a notch sensor 271, which will be described later. The notch sensor 271 may determine whether the magazine 100 is seated in the forward direction through whether the notch portion 171 is recognized in the base plate 110.

To this end, the notch portion 171 may be disposed to be spaced apart from the center based on a direction perpendicular to the height direction (Z-axis direction) of the magazine 100. For example, the notch portion 171 may be disposed to be deflected in a predetermined direction on the base plate 110. If the notch portion 171 is disposed in the exact center of the base plate 110, it may be difficult to determine whether the magazine is disposed in the forward or reverse direction even if the notch sensor 271 detects the notch portion 171.

For example, referring to the drawings, the notch portion 171 may be disposed with a bias toward either one side or the other side based on a predetermined direction (for example, magazine entry direction) of the base plate 110.

In this case, when the notch sensor 271 recognizes the notch portion 171, the state may mean ‘a state in which the magazine 110 is seated so that the notch portion 171 is disposed in front of the base plate 110.’ (This state may refer to the forward direction, referring to FIG. 7.)

In this manner, the as secondary battery manufacturing apparatus 200 recognizes the notch portion 171 disposed in the front of the magazine 100 through the notch sensor 271, it may be determined that the magazine 100 is disposed in the forward direction on the seating table 210.

Through the above-described structure, the secondary battery manufacturing apparatus 200 may determine the forward or reverse direction of the magazine 100 simply by the notch sensor 271 recognizing the presence of the notch portion 171.

Additionally, the notch portion 171 may be disposed so as not to overlap the loading space S in which the electrode plate 10 is accommodated in a predetermined direction (for example, the loading direction). As will be described later, the notch sensor 271 that recognizes the notch portion 171 may include a vision sensor that detects whether the notch portion 171 is present through a captured image.

In this case, the notch sensor 271 may capture an image in the first direction and recognize an empty space formed by the notch portion 171 or an outer border formed by the notch portion 171 in the captured image. For example, the notch sensor 271 may sense whether the notch portion 171 is recognized by using the difference in image data whether the portion extending in the first direction is blocked by the base plate 110 or open by the notch portion 171.

If the notch portion 171 is disposed to overlap the loading space S based on the loading direction (Z-axis direction), there is a risk that the accuracy of the notch sensor 271 may be reduced due to image noise of the electrode plate 10 accommodated in the loading space S. Therefore, according to some embodiments, the notch portion 171 may be disposed so as not to overlap the accommodating space.

The mark portion 173 may be disposed on a surface other than the lower surface of the magazine 100. Since the lower surface of the magazine 100 (in detail, the lower surface of the base plate 100) faces the seating table 210, it may be difficult to recognize the mark portion with sensors other than the notch sensor 271, and also, the notch portion 171 may already be provided on the lower surface of the magazine 100.

Additionally, the mark portion 173 may be disposed on a surface in a direction (for example, X-axis direction in the drawing) perpendicular to the entry direction (for example, Y-axis direction in the drawing) of the magazine 100.

When the mark portion 173 is disposed on the surface (for example, the second support plate 152 in the drawing) in the entry direction, the magazine 100 may be recognized only when it is completely seated on the seating table 210. For example, in the case in which the facing direction between the mark portion 173 and the mark sensor 273 is parallel to the entry direction, since the mark portion 173 may only be recognized when it approaches the mark sensor 273, quick recognition may be difficult.

Meanwhile, when disposed on a surface (for example, the first side frame 141 in the drawing) perpendicular to the entry direction, while the magazine 100 enters the seating table 210, the gap between the mark portion 173 and the mark sensor 273 may not be different compared to the above-described case. For example, when the facing direction between the mark portion 173 and the mark sensor 273 is disposed perpendicular to the entry direction, the mark sensor 273 may quickly recognize the mark portion 173 even before the magazine 100 is completely seated on the seating table 210.

In addition, in the case in which disposed as above, when a plurality of magazines 100 are provided and the plurality of magazines 100 enter the seating table 210 side by side, the mark portions 173 of a plurality of magazines 100 may be recognized through one mark sensor 273.

Additionally, a plurality of mark portions 173 may be provided. In this case, the plurality of mark portions 173 may be disposed not to face each other in a predetermined direction.

For example, it may be assumed that mark portions 173 are provided on both sides of the magazine 100, in detail, on the first side frame 141 and the second side frame 142, respectively. In this case, the mark sensor 273, which will be described later, may always recognize the mark portion 173 regardless of whether the magazine 100 is disposed in the forward or reverse direction, and thus the reliability of direction recognition may be reduced.

On the other hand, there is no particular limitation on the information contained in the mark portion 173 itself, as long as it indicates that the mark portion is disposed on a specific surface of the magazine 100.

For example, the mark portion 173 may include a barcode containing information such as the type and number of electrode plates 10 accommodated in the magazine 100. For example, the mark portion 173 itself may include information unrelated to the seating direction of the magazine 100.

In detail, the information contained in the mark portion 173 itself does not indicate the direction of the magazine 100, but the mark portion 173 may indicate a specific surface of the magazine 100. The mark sensor 273 may determine whether the magazine 100 is in the forward direction by sensing whether the mark portion 173 is present on the specific surface. The detailed structure of the mark sensor 273 will be described later.

One or more direction recognition units 270 may be provided. According to some embodiments, when a plurality of direction recognition units 270 are disposed, respective direction recognition units 270 may be disposed so as not to overlap each other in a predetermined direction to prevent duplicate recognition.

As an example, the direction recognition unit 270 may include at least one of a notch sensor 271 disposed below the magazine 100 or a mark sensor 273 disposed on the side of the magazine 100.

FIG. 7 is a schematic diagram illustrating determining the seating direction of a magazine using a notch portion and a notch sensor. Referring to FIG. 7, in an embodiment, the notch sensor 271 may recognize the notch portion 171 formed on the bottom of the magazine 100.

The left drawing of FIG. 7 illustrates that the notch sensor 271 recognizes the notch portion 171 (see “O” in the drawing), and the right drawing of FIG. 7 illustrates that the notch sensor 271 does not recognize the notch portion 171 (see “X” in the drawing).

As described above, the definition of ‘forward direction’ may mean a preset direction. For example, the state in which the notch sensor 271 recognizes the notch portion 171 while the magazine 100 is seated may be set to the forward direction.

In this case, it may be determined that in the left drawing of FIG. 7, the magazine 100 is seated in the forward direction, and in the right drawing of FIG. 7, the magazine 100 is seated in the reverse direction rather than the forward direction.

Additionally, the notch sensor 271 may be disposed in a position corresponding to the notch portion 171 of the magazine 100.

For example, the notch sensor 271 may be disposed to face the base plate 110 on the seating table 210. In this case, to prevent the step of the seating portion 211 due to the notch sensor 271, a sensor hole 215 is formed in the seating portion 211, and the notch sensor 271 may be accommodated in the sensor hole 215 and embedded in the seating table 210.

In addition, the notch sensor 271 is provided as a type of sensor corresponding to the type of the notch portion 171 and may recognize the presence or absence of the notch portion 171.

As described above, the notch portion 171 may be provided in a penetrating shape in the base plate 110. In this case, the notch sensor 271 may include a vision sensor that detects this penetrating empty space in a predetermined position. The notch sensor 271 recognizes the presence or absence of the penetrating shape (notch portion, 171) of the base plate 110, and may thus determine the seating direction of the magazine 100 (see FIG. 7).

However, the type of notch sensor 271 is not limited thereto. For example, the notch sensor 271 according to an embodiment is disposed to overlap the notch portion 171 in the first direction (Z-axis direction in the drawing) when the magazine 100 is seated on the seating table 210, and any structure that may detect the presence or absence of the notch portion 171 through this structure may belong to the present disclosure.

In this case, ‘overlapping’ may mean that the notch portion 171 and the notch sensor 271 are disposed side by side in the first direction and that the notch portion 171 is disposed in a position where the notch sensor 271 projects in the first direction.

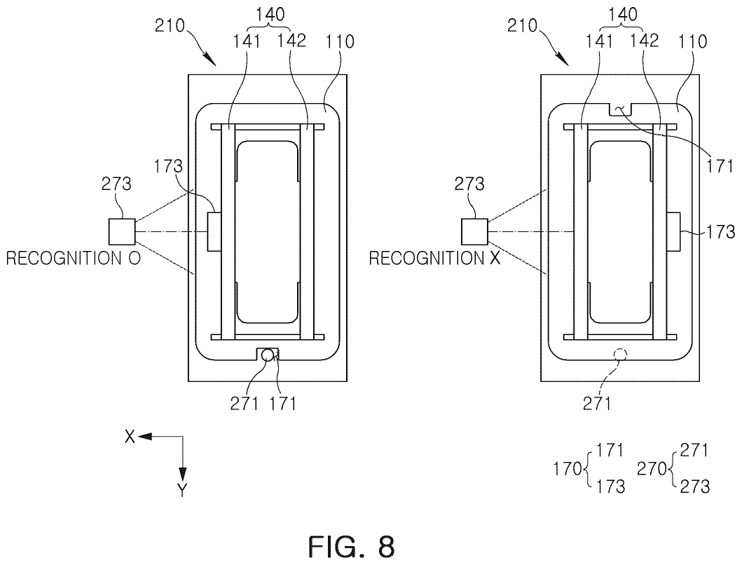

FIG. 8 is a diagram illustrating sensing the direction of the magazine 100 through the mark sensor 273 according to some embodiments.

Referring to FIG. 8, in an embodiment, the mark sensor 273 recognizes the mark portion 173 formed on the side surface of the magazine 100, and may thus determine whether the magazine 100 is seated in the forward direction.

The left drawing of FIG. 8 illustrates that the mark sensor 273 recognizes the mark portion 173 on the facing side of the magazine 100 (see “O” in the drawing), and the drawing on the right of FIG. 8 is a drawing illustrating that the mark sensor 273 does not recognize the mark portion 173 on the facing side of the magazine 100 (see “X” in the drawing).

As described above, the definition of ‘forward direction’ may be provided based on relatively pre-established concept. For example, in the state in which the mark sensor 273 is disposed to sense the surface in one direction (+X-axis direction), the recognition of the mark portion 173 may be set to the forward direction.

In this case, it may be determined that in the left drawing of FIG. 8, the magazine 100 is seated in the forward direction, and in the right drawing of FIG. 8, the magazine is seated in the reverse direction rather than the forward direction.

On the other hand, in this disclosure, “face” means to face each other directly (face-to-face), and in the left drawing of FIG. 8, the mark sensor 273 and the mark portion 173 face each other, but in the right drawing of FIG. 8, the mark sensor 273 and the mark portion 173 oppose each other without facing each other.

For example, the mark sensor 273 is disposed on the facing surface of the magazine 100 and may recognize the mark portion 173 facing the mark sensor 273 (see the left drawing of FIG. 8).

Additionally, the mark sensor 273 is provided to face the mark portion 173 and may recognize the mark portion 173. As the mark sensor 273 recognizes the mark portion, the mark sensor 273 may determine a specific surface of the magazine 100 on which the mark portion 173 is placed.

As an example, when the magazine 100 is seated, it may be assumed that ‘the first side frame 141 is disposed toward one side of the seating table 210 (+X-axis direction in the drawing)’ is set to the forward direction (see the left drawing of FIG. 8).

At this time, to determine the forward direction, the mark sensor 273 may be disposed in advance to face the surface of the seating table 210 in the one direction, and the mark portion 173 may be disposed in advance on the first side frame 141.

In this case, the fact that the mark sensor 273 recognizes the mark portion 173 means that ‘the magazine 100 is seated so that the first side frame 141 faces the one direction.’ Therefore, the secondary battery manufacturing apparatus 200 may determine that the magazine 100 is seated in the forward direction through this relationship.

For example, the secondary battery manufacturing apparatus 200 of an embodiment may determine the seating direction of the magazine 100 by combining the placement position of the mark sensor 273 and whether the mark portion 173 is recognized.

The mark sensor 273 may be disposed to face one side of the magazine where the mark portion 173 is disposed.

As described above, the mark sensor 273 may recognize whether the mark portion 173 is present by sensing a specific surface of the magazine 100 that it faces.

For example, when the mark portion 173 includes a barcode containing predetermined information, the mark sensor 273 may include a barcode reader that recognizes the barcode. In this case, the mark sensor 273 may recognize the presence or absence of a barcode and identify the specific surface of the magazine 100 where the mark portion 173 is placed.

Additionally, as described above in the description of the mark portion 173, a plurality of mark sensors 273 may be provided. The plurality of mark sensors 273 may be disposed so as not to face each other in a predetermined direction. This is because, if the mark sensors 273 are disposed on both sides of the magazine 100 (the surfaces opposing in the X-axis direction), the mark sensors 273 may recognize the mark portion 173 no matter where the mark portion 173 is disposed on one side or the other side of the magazine.

For example, the mark sensor 273 may be disposed in one direction so that the value at which the mark sensor 273 recognizes the mark portion 173 may vary depending on the forward or reverse direction of the magazine 100.

Additionally, according to some embodiments, a plurality of direction indicators 170 and a plurality of direction recognition units 270 that respectively recognize the direction indicators 170 may be disposed organically. In detail, the notch portion 171 and the notch sensor 271 recognizing the notch portion, and the mark portion 173 and the mark sensor 273 recognizing the mark portion, may be disposed together.

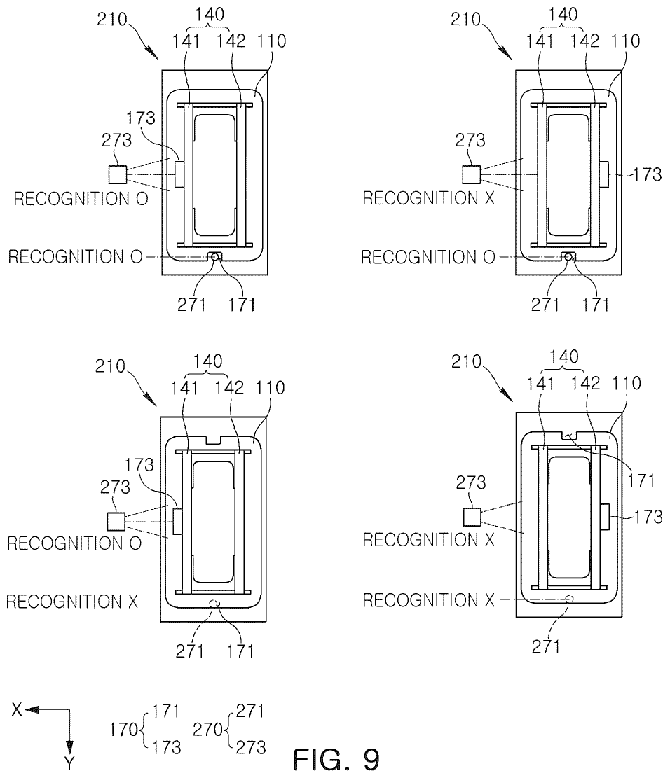

The seating direction of the magazine 100 when disposed in this manner will be described with reference to FIG. 9. FIG. 9 is a diagram illustrating sensing the direction of the magazine 100 through a plurality of direction recognition units 270 according to some embodiments.

The first drawing from the left in FIG. 9 illustrates a state in which both the notch portion 171 and the mark portion 173 are recognized through the notch sensor 271 and the mark sensor 273, respectively. The second drawing in FIG. 9 illustrates that the notch portion 171 is recognized through the notch sensor 271, but the mark sensor 273 does not recognize the mark portion 173 on one surface of the magazine 100 in one direction (in the drawing, the surface in the +X-axis direction). In the third drawing of FIG. 9, the notch portion 171 is not recognized through the notch sensor 271, but the mark portion 173 is recognized on one side-directions surface of the magazine 100 through the mark sensor 273. The fourth drawing of FIG. 9 illustrates a state in which both the notch portion 171 and the mark portion 173 are not recognized through the notch sensor 271 and the mark sensor 273, respectively.

As described above, in this case, ‘forward direction’ may mean a preset relative concept. For example, as described above in FIGS. 7 and 8, a state in which both the notch portion 171 and the mark portion 173 are recognized may be defined as the forward direction.

In this case, the first drawing from the left in FIG. 9 may be set as ‘forward direction’. ‘Reverse direction’ may be determined relatively in relation to the forward direction, and all other cases may be determined as the reverse direction (second to fourth drawings of FIG. 9).

For example, the magazine 100 may be seated on the seating table 210 in a plurality of seating directions, and one of the seating directions may be a forward direction.

In this manner, when a plurality of direction recognition units 270 are provided, a greater number of reverse direction cases may be filtered out (see FIG. 9), compared to the case in which only one direction recognition unit 270 is provided (see FIG. 7 or 8), and thus, the reliability of determination of a forward direction may be improved.

On the other hand, when the direction recognition unit 270 (for example, a notch sensor, 271) starts sensing before the magazine 100 is seated on the seating table 210, since it is before the magazine 100 enters, the direction recognition unit 270 has no choice but to determine that all direction indicators 170 are not recognized. In this case, to improve direction recognition reliability, sensing the direction indicator 170 after the magazine 100 is seated on the seating table 210 may be required.

Accordingly, the secondary battery manufacturing apparatus according to an embodiment may further include a seating sensor (not illustrated) that senses whether the magazine 100 is seated on the seating table 210. For example, after the seating sensor determines that the magazine 100 is seated on the seating table 210, the direction recognition unit 270 may sense the direction indicator 170.

For example, when the magazine 100 is seated on the seating table 210, the seating sensor generates a seating signal, and the direction recognition unit 270 may sense the direction indicator 170 when detecting the seating signal.

Hereinafter, a method of determining a seating direction of a magazine 100 according to an embodiment will be described with reference to the drawings.

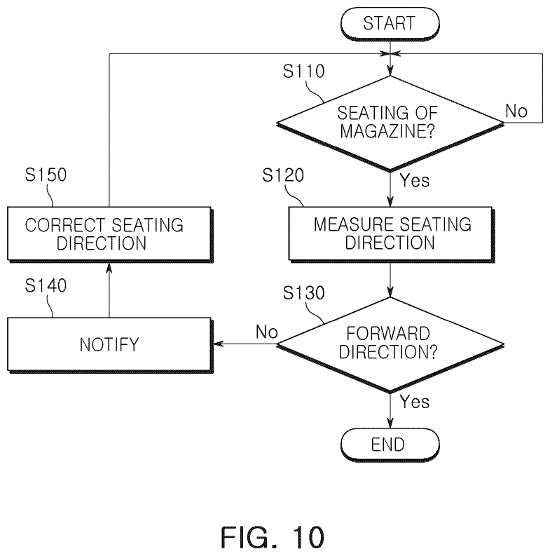

FIG. 10 is a flowchart of a method of determining a forward direction of a magazine according to an embodiment.

Referring to FIG. 10, a secondary battery manufacturing method according to an embodiment may include a seating determination operation (S110) to sense and determine whether the magazine 100 is seated on the seating table 210, a direction measurement operation (S120) in which the direction recognition unit 270 measures the seating direction of the magazine 100 by sensing the direction indicator 170 of the magazine 100, and a direction determination operation (S130) of determining whether the magazine 100 is seated in the forward direction based on the sensed information.

The seating determination operation (S110) is an operation of sensing and determining whether the magazine 100 is seated on the seating table 210 using a seating sensor.

According to an embodiment, only when it is determined that the magazine 100 is seated on the seating table 210, the direction recognition unit 270 may sense the direction indicator 170. This is because the direction indicator 170 cannot be accurately sensed before the magazine 100 is seated on the seating table 210.

According to an embodiment, the above-described determination operations may be performed with a separate control unit (not illustrated). As an example, the seating sensor senses the magazine 100 and transmits sensing data about whether the magazine 100 is seated to the control unit, and the control unit may determine whether the magazine 100 is seated through the sensing data.

If it is not detected that the magazine 100 is seated, it may wait for the magazine 100 to be seated (S110, NO).

The direction measurement operation (S120) is an operation in which the direction recognition unit 270 measures whether the direction indicator 170 is recognized by sensing the direction indicator 170 provided in the magazine 100.

As an example, the notch sensor 271 of the direction recognition unit 270 may detect the presence or absence of the notch portion 171, and the mark sensor 273 may detect the presence or absence of the mark portion 173.

The direction determination operation (S130) is an operation of determining whether the magazine 100 seated on the seating table 210 is currently seated in the forward direction based on the real-time sensing data of the direction recognition unit 270.

As described above, ‘forward direction’ may be any preset direction, and ‘reverse direction’ may refer to any case other than the forward direction.

For example, the forward direction may refer to the direction of the magazine 100 in which all of the plurality of direction indicators 170 are detected. For example, when both the notch portion 171 and the mark portion 173 are detected, it may be determined that the direction is forward, and if either one is not detected, it may be determined to be in the reverse direction (in this example, the first drawing from the left of FIG. 9 may be the forward direction). As another example, in the present disclosure, the forward direction may refer to the seating direction of the magazine 100 in a state in which all of the plurality of direction indicators 170 are not detected. For example, only when neither the notch portion 171 nor the mark portion 173 is detected, it may be determined to be in the forward direction, and if any one thereof is detected, it may be determined to be in the reverse direction. (In this example, the fourth drawing from the left in FIG. 9 may be the forward direction).

On the other hand, as described above, in the seating determination operation (S110), not only may the direction recognition unit 270 perform the determination of the forward direction, but the control unit may also determine the forward direction by transmitting direction sensing data to a separate control unit.

As an example, the direction recognition unit 270 transmits information such as whether or not each direction indicator 170 is recognized to the control unit, and the control unit may determine whether the magazine 100 is seated in the forward or reverse direction by comparing the received data with the preset definition of the forward direction.

When it is determined that the magazine 100 is seated in the forward direction on the seating table 210 (S130, Yes), the subsequent process of secondary battery manufacturing may be continued.

For example, in the secondary battery manufacturing apparatus 200, the electrode plate 10 loaded in the magazine 100 may be withdrawn from the magazine 100, and then a stacking process of sequentially stacking an electrode plate 10 with a different electrical polarity may be performed.

If it is not determined that the magazine 100 is seated in the forward direction on the seating table 210 (S130, No), the secondary battery manufacturing apparatus may notify information through a notification unit (not illustrated) (S140).

For example, when any one of the direction indicators 170 is not recognized, the secondary battery manufacturing apparatus may notify the operator with perceivable information such as visual and auditory information.

Afterwards, the seating direction of the magazine 100 mounted on the seating table 210 may be corrected (S150). This operation may be performed by correcting the seating direction of the magazine 100 through a separate position correction unit (not illustrated) in the secondary battery manufacturing apparatus 200, or by the operator correcting the seating direction of the magazine 100.

Next, the seating direction determination operation (S110) may be re-performed by the seating sensor re-sensing whether the magazine 100 is seated on the seating table 210.

On the other hand, the above-described operations are just an example, and any operation may be omitted. For example, if the forward direction determination operation (S130) is performed after the direction measurement operation (S120), all other operations may be understood to belong to the present disclosure even if they are omitted or added in between.

As set forth above, according to some embodiments, there may be provided a magazine, in which a safety in a secondary battery manufacturing process may be improved by preventing a magazine in which electrodes are loaded from being inserted in a reverse direction, and a secondary battery manufacturing apparatus including the same.

According to some embodiments, a magazine in which the size of the magazine is variable depending on the size of loaded electrodes therein, thereby stably supporting electrodes, and a secondary battery manufacturing apparatus including the same, may be provided.

Only specific examples of implementations of certain embodiments are described. Variations, improvements and enhancements of the disclosed embodiments and other embodiments may be made based on the disclosure of this patent document.

What is claimed is:

1. A secondary battery manufacturing apparatus comprising:
a seating table;
a magazine seated on the seating table and in which at least one electrode plate is loaded in a first direction;
a direction indicator provided with the magazine and indicating a relative direction of the magazine with respect to the seating table; and
a direction recognition unit sensing the direction indicator and deriving a direction in which the magazine has been seated on the seating table.

2. The secondary battery manufacturing apparatus of claim 1, wherein the magazine enters in a second direction, perpendicular to the first direction, and is seated on the seating table.

3. The secondary battery manufacturing apparatus of claim 2, wherein the direction indicator is disposed on a first surface of the magazine,
wherein the first surface of the magazine is a surface disposed in a direction, perpendicular to the second direction, among surfaces of the magazine.

4. The secondary battery manufacturing apparatus of claim 1, wherein the magazine includes a base plate mounted on the seating table,
the direction indicator includes a notch portion provided on the base plate to face the seating table, and
the direction recognition unit includes a notch sensor disposed on the seating table to face the base plate and sensing the notch portion.

5. The secondary battery manufacturing apparatus of claim 4, wherein the notch portion is provided in the base plate by penetrating through the base plate in the first direction, and
the notch sensor recognizes whether the notch portion is located in a position extending from the notch sensor in the first direction.

6. The secondary battery manufacturing apparatus of claim 5, wherein, when the magazine is seated on the seating table, the magazine is seated in one direction among a forward direction in which the notch portion is disposed in a position extending from the notch sensor in the first direction, and a reverse direction other than the forward direction, and
the notch sensor senses the magazine having been seated on the seating table in the forward direction.

7. The secondary battery manufacturing apparatus of claim 5, wherein the notch sensor senses whether the notch portion is disposed in a position projected by the notch sensor in the first direction in a state in which the base plate is seated on the seating table.

8. The secondary battery manufacturing apparatus of claim 7, wherein the notch portion is disposed closer to either one side or the other side of the base plate based on a second direction, perpendicular to the first direction.

9. The secondary battery manufacturing apparatus of claim 1, wherein the direction indicator includes a mark portion disposed in a direction, perpendicular to the first direction of the magazine, and exposed externally, and
the direction recognition unit includes a mark sensor disposed to face the magazine seated on the seating table in a direction, perpendicular to the first direction, and sensing the mark portion.

10. The secondary battery manufacturing apparatus of claim 9, wherein the magazine includes a first surface facing the mark sensor, and the magazine is seated on the seating table to be disposed in one of a forward direction in which the mark portion is disposed on the first surface, or a reverse direction rather than the forward direction.

11. The secondary battery manufacturing apparatus of claim 10, wherein the mark sensor senses whether the mark portion is disposed on the first surface of the magazine.

12. The secondary battery manufacturing apparatus of claim 9, wherein the mark sensor senses whether the mark portion is disposed on a surface of the magazine, facing the mark sensor, among surfaces of the magazine, when the magazine is seated on the seating table.

13. The secondary battery manufacturing apparatus of claim 1, further comprising a seating sensor detecting whether the magazine is seated on the seating table and generating a seating signal,
wherein the direction recognition unit senses the direction indicator when the seating signal is detected.

14. A magazine comprising:
a loading space in which an electrode plate with an uncoated portion protruding in a predetermined direction is loaded in a first direction;
a loading guide having the loading space; and
a direction indicator indicating a protruding direction of the uncoated portion of the electrode plate,
wherein the direction indicator includes at least one of a notch portion disposed below the loading guide in the first direction, and a mark portion provided in a direction, perpendicular to the first direction, and exposed externally.

15. The magazine of claim 14, further comprising a base plate supporting a lower portion of the loading guide,
wherein the notch portion is disposed so as not to overlap the loading space in the first direction in the base plate.

16. The magazine of claim 14, wherein the loading guide is provided to be movable in a direction, perpendicular to the first direction, and to change a size of the loading space.

17. The magazine of claim 16, wherein the magazine further includes a moving frame supporting an end of the loading guide in the first direction and having a moving guide hole provided in a second direction, perpendicular to the first direction, and
the loading guide is movable in the second direction along the moving guide hole of the moving frame.

18. The magazine of claim 17, wherein the magazine further includes a side frame supporting a side portion of the loading guide and having a side guide hole extending in the second direction, and
the loading guide is movable in the second direction along the moving guide hole and the side guide hole.

19. The magazine of claim 18, further comprising a base plate supporting the moving frame and having a base guide hole extending in a third direction, perpendicular to the first and second directions,
wherein the moving frame is provided to be movable in the third direction along the base guide hole together with the loading guide.

20. The magazine of claim 19, wherein the magazine further includes a support plate disposed in the second direction of the loading guide, supporting the side frame and having a support guide hole extending in the third direction, and
the side frame is movable in the third direction along the support guide hole together with the loading guide.
